(19) United States
(12) Patent Application Publication
(10) Pub. No.: US 2010/0319046 A1
(43) Pub. Date: Dec. 16, 2010

(54) SYSTEM AND METHOD TO EXPAND CATV TRANSMISSION SPECTRUM USING HIGH FREQUENCY SPECTRUM OVERLAYS

(76) Inventors: Yechzkel ALBAG, Nordiya (IL); Yeshayahu Strull, Tel Aviv (IL); Hillel Weinstein, New York, NY (US); Baruch Orbach, Ashkelon (IL)

Correspondence Address: Pearl Cohen Zedek Latzer, LLP, 1500 Broadway, 12th Floor, New York, NY, 10036, US

(21) Appl. No.: 12/783,941

(22) Filed: May 20, 2010

Related U.S. Application Data
(63) Continuation of application No. 10/513,538, filed on Jun. 21, 2005, now abandoned.
Application No. 10/513,538 is a continuation-in-part of application No. 09/830,015, filed on Jul. 20, 2001, now abandoned.

(30) Foreign Application Priority Data
Oct. 16, 2000 (IL) PCT/IL00/00655

(51) Int. Cl. H04N 7/173; H04B 1/69

(52) U.S. Cl. 725/131; 375/130; 375/E01.001

(57) ABSTRACT

A system and method for the expansion of the spectrum by the generation and introduction of high frequency spectrum overlays is disclosed. In an electronic content distribution system a plurality of input stream are combined at a head end into two combined signals having separate frequency band ranges. The signals are transmitted to the network and are dynamically combined into a single signal where the spectral composition of the signal is controlled by pre-defined parameters. The first signal carries a plurality of existing channels while the second signal could carry an additional set of channels. The second signal could carry spectral overlays generated from specific input streams the in accordance with pre-defined system parameters. The spectral overlays are selectively extracted from the second signal and introduced into the combined signal in the network in accordance with pre-defined subscriber-specific information.

### RELATED APPLICATIONS

The present application is generally related to co-pending PCT application No. PCT/IL00/00655 by Zeev Averbuch and Dr. Hillel Weinstein entitled “System and Method for Expanding the Operational Bandwidth of a Communication System”, filed 16^{th} Nov. 2000 which is incorporated herein by reference.

### BACKGROUND OF THE INVENTION

1. Field of the Invention

The present invention relates generally to cable television distribution networks. More particularly the present invention relates to the expansion of the transmission spectrum of a cable television distribution system by the selective generation and insertion of high frequency spectrum overlays.

2. Discussion of the Related Art

The recent introduction of digital technology for cable distribution plants has provided the opportunity for cable operators to introduce new and sophisticated services into their networks. Such services include the distribution of additional program content and new application content, such as the supply of digital video programs, the enabling of data communication network access via cable, telephony over cable applications, and the like. These new services are typically implemented as supplements to the distribution of the already existing analog video programming content, in order provide downward compatibility to the distribution schema of the currently operating cable networks. Traditionally, analog services providing video programming content have been carried over an electronic signal having a frequency range of about 75-500 MHz. The new digital services could be introduced only following a suitable expansion of the transmission spectrum or the frequency bandwidth of the carrier signal sent and received across the physical distribution path. Thus, the recently introduced digital services are carried over an extension portion of the traditional spectrum, which typically spans the frequency range of 500-750 MHz or 500-860 MHz. FIG. 1 illustrates graphically the expanded frequency spectrum of a CATV coaxial plant, which was upgraded to provide digital services. The frequency spectrum is divided into various pre-determined portions of the entire frequency bandwidth where each section is dedicated in a pre-determined manner for the various services delivered in a specific direction within the cable plant. Thus, the frequency range of about 5 to 42 MHz (10) or the about 5 to 65 MHz (10) is dedicated to the upstream traffic and designed to be sent from the subscribers of the networks to a cable network head end unit for purposes of individual programming requests for video-on-demand, for audio-on-demand (radio and music channels), for Internet access initiation, for e-mail transmission, and for other specific service requests, such as Automatic Program Guides (APG) download, and the like. Where cable telephony services are available the upstream traffic specific frequency range 10 is further utilized for the transmission of phone connection requests for the establishment of a telephone connection and for the transmission of the customer-to-head end portion of the established phone call. The upstream portion of the signal is typically, modulated in one of the known modulation techniques, such as QAM16, QPSK, FSK, and the like. Commonly, the frequency range of about 78 MHz to 108 MHz (12) or the about 88 to 108 MHz (12) is utilized for the downstream traffic consisting of the audio content provided by suitable audio sources such as remote FM radio stations, local music channels provided by the head end and associated program content storages and the like. The existing analog video channels content is transmitted via the about 130 MHz to 500 MHz frequency bandwidth portion 14 or the about 130 MHz to 550 MHz frequency bandwidth portion. The analog channels constitute the traditional TV channels that are generated by remote TV network stations, or by local programming units and are arranged appropriately into frequency range slots by the head end units of the cable network. The new digital television content provided by digital TV broadcasting or generated locally are transmitted via the extended portion of the spectrum, i.e. the about 450/550 MHz to 750 MHz 16 frequency portion of the upgraded spectrum bandwidth. The new digital services typically utilize known highly efficient modulation schemes such as QAM64, QAM128, QAM256, which capable of providing transmission bit-rates of about 2.5 Mbps to 4 Mbps. A supplementary portion of the transmission spectrum spanning the about 750 MHz to the 860 MHz 18 frequency band is used typically for additional digital services, such as Voice over IP (VoIP), Internet access and the like.

The analog television channel allocation in a CATV plant was originally engineered to operate in the frequency range of about 48 MHz to 550 MHz (10+12+14) only. In order to receive and appropriately handle the analog channels a subscriber is required to install a set of customer premises equipment such as cable modems, set top boxes and the like, which are operative in the processing of the incoming analog signals. As a result there are hundreds of millions of set top boxes or converters capable of handling video and audio content in analog form only. As the analog set top boxes were not designed to handle digital traffic, the introduction of the new digital technology providing content in digital format requires the replacement of the original analog set top boxes with new digital set top boxes capable of handling signals carrying content in digitally encoded format. In addition to the capability of handling digital inputs the digital set top box (DSTB) can feed standard television inputs, such as audio/video, SCART or SVHS and a modulated RF carrier connecting an analog channel to the antenna input.

FIG. 2 illustrates the simplified structure of an analog set top box (ASTB) 19 and the functional input and output lines thereof, as known in the art. The ASTB 19 includes an RF tuner 20 and an RF/AV converter 22. The box 19 is fed by a signal carrying content information modulated such the resulting frequency elements of the signal span an about 48 MHz to 550 MHz frequency band. The signal is transmitted from the network head end through the cable plant and eventually interfaces with the ASTB via a specifically installed wall outlet 17. The RF tuner 20 is controlled typically by a remote controller 30, operated by a subscriber, in order to provide for the selective display of the desired channels. The RF tuner 20 selects the suitable analog channel and feeds the isolated frequency elements to the format converter 22. The signal is appropriately converted into a suitable format for display and sent either via the output port 28 to a pre-tuned TV channel 28 or optionally via the audio/video output ports 24, 26 to additional display equipment.

FIG. 2 illustrates the simplified structure of a digital set top box (DSTB) 34 and the functional input and output lines thereof, as known in the art. The DSTB 34 includes an RF tuner 36 and an RF/MPEG2/AV converter 38. The box 34 is fed by an electrical signal the frequency range of which spans an about 130 MHz to 860 MHz. The signal carries both analog and digital content transmitted from the network head end through the cable plant. The signal interfaces with the DSTB via a specifically installed wall outlet 32 and fed to the RF tuner 36, which is controlled typically by a remote controller device 46, operated by a subscriber to provide for the selection of the desired analog/digital channels. The tuner 36 selects the suitable analog/digital channel and feeds the isolated frequency elements associated with the selected channel to the converter device 22. The, signal is appropriately converted for display and sent either via the output port 28 to a pre-tuned TV channel 28 or optionally via the stereo audio output port 40 and video output ports 42 to the appropriate display equipment.

The CATV operators must continue provide analog contents within analog channels for economic, regulatory, and legal reasons. As a result the about 130 MHz to 450/550 MHz frequency band must remain dedicated to the transmission of the traditional analog channels. The transmission of the new digital channels is therefore limited to the about 450/550 MHz to 750/860 MHz bandwidth. Consequently the number of digital channels that can be provided to the subscriber is limited by the available bandwidth. Relentless commercial competition among the different CATV operators requires the continuous improvement of the services provided to their subscribers, such as the addition of new video and audio channels, more flexible programming, enhanced programming mix, and other advanced services. The above-mentioned limitation concerning the availability of the bandwidth for digital services substantially hinders the ability of the CATV operators to compete successfully on today's extremely dynamic market where new cable network-related services are being developed and implemented continuously and new requests are made constantly by the increasingly sophisticated customer base concerning the enhancement of the desired programming mix.

It would be readily understood by one with ordinary skills in the art that there is a need for a system and method to significantly increase the transmission capacity of the existing cable distribution networks. The enhanced transmission capacity could provide the option of adding new advanced digital channels and digital services desired by the subscribers of the networks.

### SUMMARY OF THE PRESENT INVENTION

One aspect of the present invention regards an electronic content distribution network and a system therein designed and implemented for the expansion of the frequency spectrum by the selective generation and introduction of high frequency spectrum overlays. The system includes the elements of: an extended network head end unit to provide means for the processing of a plurality of input streams, means for the combining of the input-streams into at least two separate combined signals, means for the transmission of the at least two combined separate signals to the continuance of the electronic content distribution network and means for controlling the at least one set top box device, at least one extended hub station to receive the first combined signal and the second combined signal from the extended network head end, to combine the first combined signal and the second combined signal to at least one combined signal, and to amplify the at least one combined signal, a first amplifying extended splitter devices to selectively amplify and process the constituent portions of the at least one combined input signal, a second amplifying extended splitter device to selectively amplify and process the constituent portion of the at least one combined input signal and at least one extended set top box to separate the at least one output signal into at least two output signals.

A second aspect of the present invention regards an electronic content distribution network and a method for the expansion of the frequency spectrum by the selective generation and introduction of high frequency spectrum overlays. The method includes the following steps: at an extended electronic content distribution network head end combining a plurality of analog streams, digital streams and downstream data streams into a first combined signal modulated across an about a 50 MHz to 860 MHz frequency range, at the extended electronic content distribution network head end combining a plurality of digital streams into a second combined signal modulated across an about 1 GHz to 3 GHz frequency range, transmitting the first and the second combined signals downstream to an extended content distribution network hub station, at the extended hub station frequency converting the first and second combined signal in order to create at least one combined signal across an about 150 MHz to 860 MHz frequency range, and transmitting the at least one combined signal downstream to at least one extended set top box installed at the premises of at least one subscriber thereby generating a downstream transmission spectrum of an about 150 MHz to 860 MHz frequency range that includes analog channels, digital channels and downstream data channels.

A third aspect of the present invention regards an electronic content distribution network and a method for the expansion of the frequency spectrum by the selective generation and introduction of high frequency spectrum overlays. The method includes the following steps: at an extended electronic content distribution network head end combining a plurality of analog streams, digital streams and downstream data streams into a first combined signal modulated across an about a 50 MHz to 860 MHz frequency range, at the extended electronic content distribution network head end generating at least one spectrum overlay consisting of a plurality of digital channels in accordance with pre-defined control information by multiplexing the specific digital channels into a second signal modulated across an about 1 GHz to 3 GHz frequency range, transmitting the first and the second combined signals downstream to the continuance of the electronic content distribution network, determining at a pre-defined control node the desired combination of channels for a specific network subscriber and for a specific group of network subscribers, selecting the at least one spectrum overlay in accordance with the result of the determination, overlaying the first signal modulated across an about 50 MHz to 860 MHz frequency range with the selected spectrum overlay and transmitting the resulting signal downstream to at least one extended set top box installed at the premises of at least one network subscriber thereby selectively generating at least one specific transmission spectrum including a pre-selected combination of analog channels, digital channels and downstream data channels to the at least one network subscriber.

A fourth aspect of the present invention regards an electronic content distribution network and a system for the expansion of the frequency spectrum by the selective generation and introduction of high frequency spectrum overlays. The system consists of an extended network head end unit to provide means for the processing of a plurality of input streams, means for the combining of the input streams into at least two separate combined signals, means for the transmission of the at least two combined separate signals to the continuance of the electronic content distribution network and means for controlling the at least one set top box device, at least one extended hub station to receive the first combined signal and the second combined signal from the extended network head end, to combine the first combined signal and the second combined signal to at least one combined signal, and to amplify the at least one combined signal, a amplification element placed in parallel to a line extender device devices to selectively amplify and process the constituent portions of the at least one combined input signal, and at least one extended set top box to separate the at least one output signal into at least two output signals.

### BRIEF DESCRIPTION OF THE DRAWINGS

The present invention will be understood and appreciated more fully from the following detailed description taken in conjunction with the drawings in which:

FIG. 1 shows the expanded transmission frequency bandwidth of a CATV network distributing both analog and digital channels, as known in the art;

FIG. 2 is a schematic illustration of analog set top box (ASTB) used as a key component associated with the customer premises equipment (CPE), as known in the art;

FIG. 3 is a schematic illustration of a digital set top box (DSTB) used as a key component associated with the customer premises equipment (CPE), as known in the art;

FIG. 4 is a schematic illustration of the programming matrix of an extended frequency bandwidth CATV network supporting the distribution of digital channels, as known in the art;

FIG. 5 is a schematic illustration of the programming matrix of a CATV network including the proposed eXtended Digital TeleVision (XDTV) system, in accordance with the first preferred embodiment of the present invention;

FIG. 6 illustrates the novel transmission spectrum of CATV network including the proposed XDTV system, in accordance with the first preferred embodiment of the present invention;

FIG. 7 illustrates the transmission spectrum of a CATV network including the proposed Indexed eXtended Digital TeleVision (IXDTV) system, in accordance with first preferred embodiment of the present invention;

FIG. 8 is a schematic illustration of the eXtended Set Top Box (XSTB) as an operative component of a CPE and which includes support for the IXDTV system, in accordance with the first preferred embodiment of the present invention;

FIG. 9 illustrates the functional components of the Frequency Overlay Method (FOM) of the proposed XDTV system, in accordance with the second preferred embodiment of the present invention;

FIG. 10 is a schematic illustration of the proposed XDTV system components with particular emphasis on the proposed Amplifying eXtended Splitter (AMXSP) device, in accordance with the second preferred embodiment of the present invention;

FIG. 11 illustrates a set of exemplary configurations of the proposed XDTV system using diverse functionality AMXSP devices, in accordance with the second preferred embodiment of the present invention; and

FIG. 12 is a schematic illustration of the proposed XSTB device, in accordance with the second preferred embodiment of the present invention.

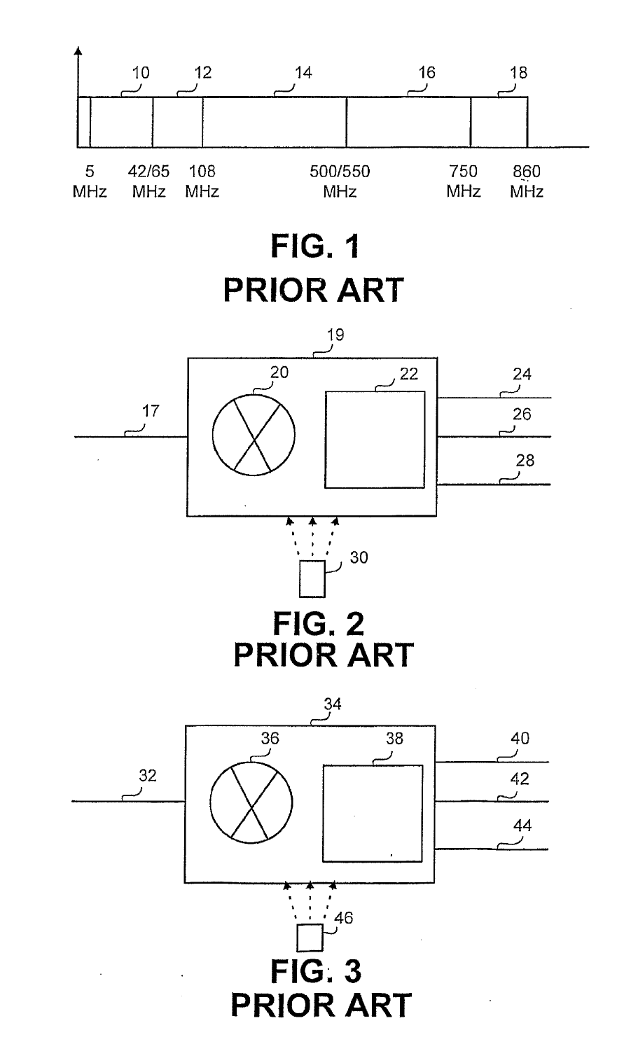

### ABBREVIATIONS AND ACRONYMS

AMXSP—Amplifying Extended Splitter

ASTB—Analog Set Top Box

BPF—Band Pass Filter

CATV—Cable Television or Community Antenna Television

CPE—Customer Premises Equipment

DS—Downstream

DSTB—Digital Set Top Box

IXDTV—Indexed Extended Digital Television

LEX—Line Extender

MCU—Micro Controller Unit

LPF—Low Pass Filter

PLL—Phase Locked Loop

US—Upstream

XTB—Extended Top Box

VCO—Voltage Controlled Oscillator

XDTV—Extended Digital Television

### DETAILED DESCRIPTION OF THE PREFERRED EMBODIMENT

A system and method for the expansion of the transmission frequency spectrum of a CATV network by the selective generation and insertion of high frequency spectrum overlays is disclosed. The proposed system and will be referred to hereunder as Extended Digital Television or by the representative acronym XDTV. The operation of the XDTV system and method is substantially based on the system and method concepts disclosed in the co-pending PCT application No. PCT/IL00/00655 entitled “System and Method for Expanding the Operational Bandwidth of a Communication System”, which in incorporated herein by reference. As indicated in the above-mentioned title, the object of the co-pending patent application is the expansion of the operational bandwidth of a CATV distribution network up to about 3 GHz and above. The present application will not include a detailed description of the referenced patent application and the reader of this text is directed to refer to the original patent application for the ready understanding of the system, technology techniques and methods proposed for the accomplishment of the above-mentioned objective.

The preferred embodiments of the present invention are described as operating within a cable television (CATV) distribution network. It would be easily understood by one with ordinary skills in the art that the CATV network as the operating environment is provided in the description as an exemplary environment only. In other preferred embodiments of the present invention the concepts underlying the present invention could be utilized in diverse other networks, such as satellite networks, mobile cellular networks, data communication networks, local networks, airborne networks, space-based networks and the like. The following description was not means to be limiting to the possible implementations of the invention using other networks, components, elements, applications, values and the like. The limits of the present invention will be defined only in the attached claims.

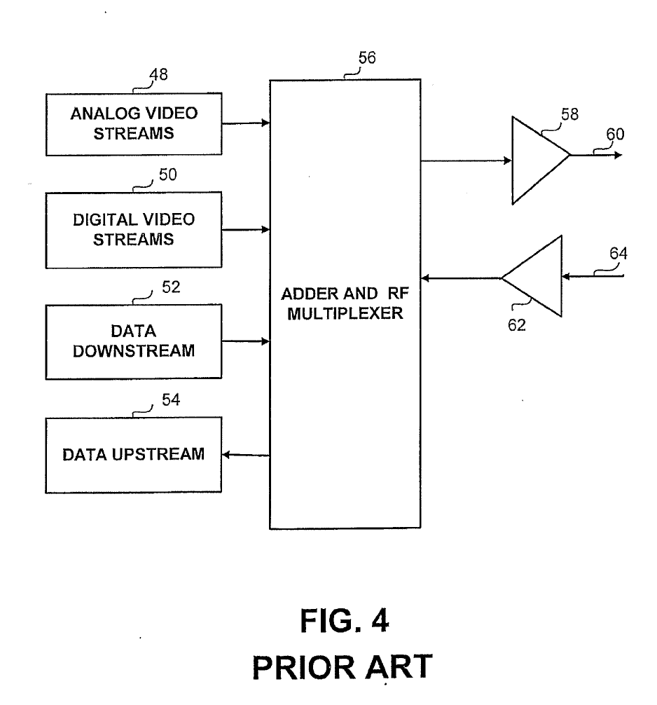

The XDTV system and method proposed by the present invention is implemented via a series of extended frequency up converter devices installed in the CATV head end, in one or more hub stations or other control nodes distributed across the CATV distribution network. A plurality of externally received or locally generated digital streams associated with a plurality of digitally-formatted programs are processed, decoded, sorted, organized, multiplexed, and introduced into a combined electronic signal transmittable through the cable plant to the subscribers in either in a pre-determined, in a dynamic or in a selective manner. The set of functional devices and the interconnections there between, which are operative in the generation of the combined signal generated from the plurality of input channels is typically referred to as the programming matrix. FIG. 4 describes the structure and the constituent components of the programming matrix that is known in the art. The matrix 71 is shown prior to the performance of the modifications introduced for the implementation of the proposed XDTV system and method. An adder and multiplexer unit 56 either at a head end, a hub station or other control node of a CATV distribution network receives a plurality of streams including analog video streams 48, digital video streams 50, and downstream data streams 52. The adder and multiplexer unit 56 processes the various streams in a pre-defined or dynamic manner by the pre-set or selective insertion of the entire set or various sub-sets of the input streams into a combined electronic signal having the frequency bandwidth range of about 50 MHz to 450/550 MHz. The signal is suitably amplified at 58 and fed downstream 60 via the cable plant to the network customers' CPE. The cable plant consists of a plurality of suitable signal handling units such as electro optical (E/O) 60 converters, amplifiers, splitters, hub stations, and the like interconnected by coaxial cable, fiber optic cables or the combination thereof. Requests submitted by the network customers are introduced into the signal and sent upstream 64 via the plant consisting of appropriate cables and processing devices. The upstream signal is fed into the adder and multiplexer unit 56 that isolates the upstream portion of the combined signal. The upstream portion of the signal includes typically upstream data that is fed to the data upstream port 54 and sent to the appropriate upstream data processors such as the head end controller units, data communication network interfaces, satellite interfaces, video-on-demand and audio-on-demand controllers, content stores and the like. The analog streams, digital video streams, upstream streams and downstream data streams are modulated selectively in such a manner as to generate a combined signal structured such that each stream is introduced into the signal within the limits of its pre-defined frequency band.

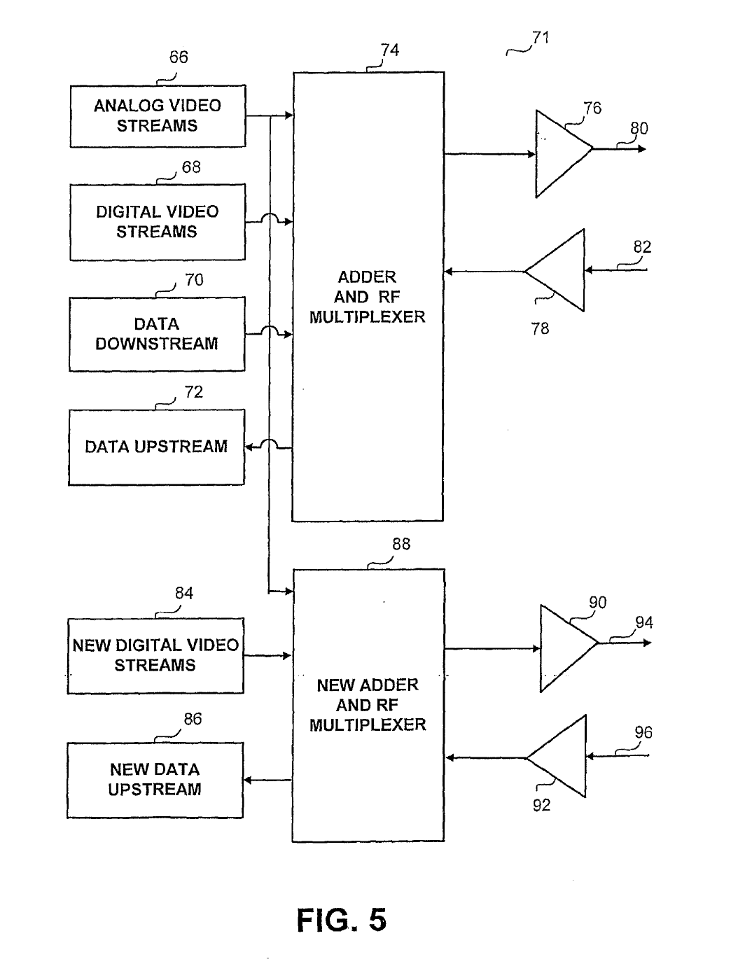

FIG. 5 shows the schematic diagram of the programming matrix resulting from the implementation of the system of method of the XDTV in accordance with the first embodiment of the present invention. In addition to the adder and RF multiplexer unit 74, which receives analog video streams 66, digital video streams 68, downstream data streams 70 and upstream data 82 from the CPEs of the subscribers and feeding the downstream signal 80 to the network and the upstream data streams 72 to the suitable devices, a new adder and RF multiplexer unit 88 is installed in the head end, in one or more the hub stations, or any other control node across the network. The unit 88 receives new digital video streams 84 for multiplexing and processing. The processed signal is sent downstream 94 to the CATV network. New upstream data signals 96 from the subscribers are fed into the programming matrix and after suitable handling such as de-multiplexing and isolation sent through a suitable port 86 to the appropriate components for processing. The new adder and RF multiplexer unit 88 further receives the existing analog streams 66 and feds the de-multiplexed upstream data streams 72. The additional digital content 84, 86 are carried by an additional optical subsystem, in the upstream and the downstream. Optionally a group of channels are frequency-converted at a specific fiber node to a different frequency range and are particularly received by a specific group of subscribers.

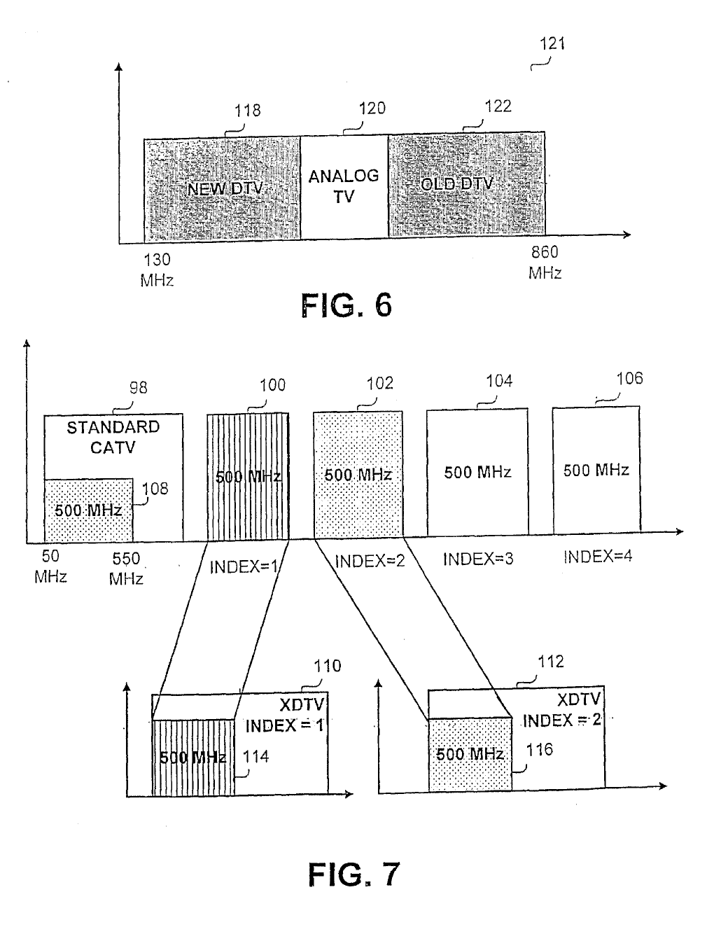

FIG. 6 depicts the resulting new digital spectrum for subscribers having a DSTB. In the first preferred embodiment of the invention, the existing analog spectrum is available yet the bandwidth of the digital spectrum is enlarged by the overlay in the lower half of the available spectrum. Thus the new digital spectrum 121 spans a frequency bandwidth of about 130 MHz to 860 MHz provided by existing technologies and includes in a pre-determined manner a new digital TV portion 118, an analog TV portion 120, and an old digital TV portion 122. The rationale behind the concept is that while an analog stream is exclusively occupies a transmission channel having a specific frequency range value, several digital streams could occupy a single common transmission channel having identical size. Consequently the re-organization of the location of the channels within the given available signal spectrum will allow for the addition of new digital streams. As a result the transmission capacity of the cable plant will be substantially increased, the amount of content information being distributed simultaneously will be enhanced and network operators will be enabled to enhance the programming mix, the programming flexibility, and the number of useful services provided. Thereby in a cost-effective and sufficient manner the implementation of the system and method proposed by the present invention will affect heightened subscriber satisfaction.

The system and method described in the co-pending patent application and included herein by reference creates a new spectrum for the coaxial section of an hybrid fiber coax (HFC) network by about 2 GHz where the new spectrum extends from about 1 GHz to about 3 GHz and above. This new spectrum can accommodate one than one spectral overlay. Assuming each overlay is defined as having a frequency range of about 500 MHz about four spectral overlays can be implemented in a network consequent to the performance of specific hardware and programming upgrades that are operative in the creation of the new spectrum. FIG. 7 shows the technique for generating and implementing indexed spectral overlays. The system and method for the creation of the overlays will be referred to hereinafter as Indexed Extended Digital Television (IXDTV) system and method. Each spectral overlay can be indexed with a different up-converter or down-converter frequency in such a manner that it can viewed by a different segment of the coaxial cable plant. Thus, the about four spectral overlays create about four parallel virtual segments in accordance with a predefined programming plan. The programming matrix at the head end generates a standard CATV 98 spectrum spanning a frequency range of about 50 MHz to about 860 MHz. The about 500 MHz frequency range 108 across the frequency range of 50 MHz to about 550 MHz includes a standard package of provided channels that could include upstream data channels, downstream data channels, analog channels and existing digital channels. The IXDTV system and method further provides the option of generating one or more specific spectrum overlays 100, 102, 104, 106. In the preferred embodiment of the present invention the overlays 100, 102, 104, 106 span an about 500 MHz frequency band. In other preferred embodiments other bandwidths could be used. The overlays 100, 102, 104, 106 are introduced into the substantially expanded 3 GHz frequency bandwidth region provided by the system and method proposed in the co-pending patent application. The specific spectrum overlays 100, 102, 104, 106 are generated in the head end, in one or more hub stations or in other control nodes in accordance with the suitable definitions of one or more programming packages that are specifically intended for distribution to a requesting group of subscribers. In the set top boxes installed at the premises of the subscribers subscriber suitable frequency converter units will effect the overlay of the original CATV spectrum band 110 with the appropriately requested; programmed and converted specific spectral overlay 114 or the overlay of the original CATV spectrum band 112 with the appropriately requested, programmed and converted specific spectral overlay 116. Thus, within each set top box device within the network in accordance to specific pre-determined definitions either the standard CATV spectrum 98 will fed to the display devices of the subscriber without modification or the standard CATV spectrum 98 will be overlaid by one of the spectral overlays 100, 102, 104, 106 in order to generate a baseline spectrum 110 or 112 overlaid by the spectrum overlay 114, 116 that include a specific programming package for the particular subscribers. It would be readily perceived by one with ordinary skills in the art that in other preferred embodiments of the present invention different values could be used concerning the size of the spectrum overlays and the number of overlays generated.

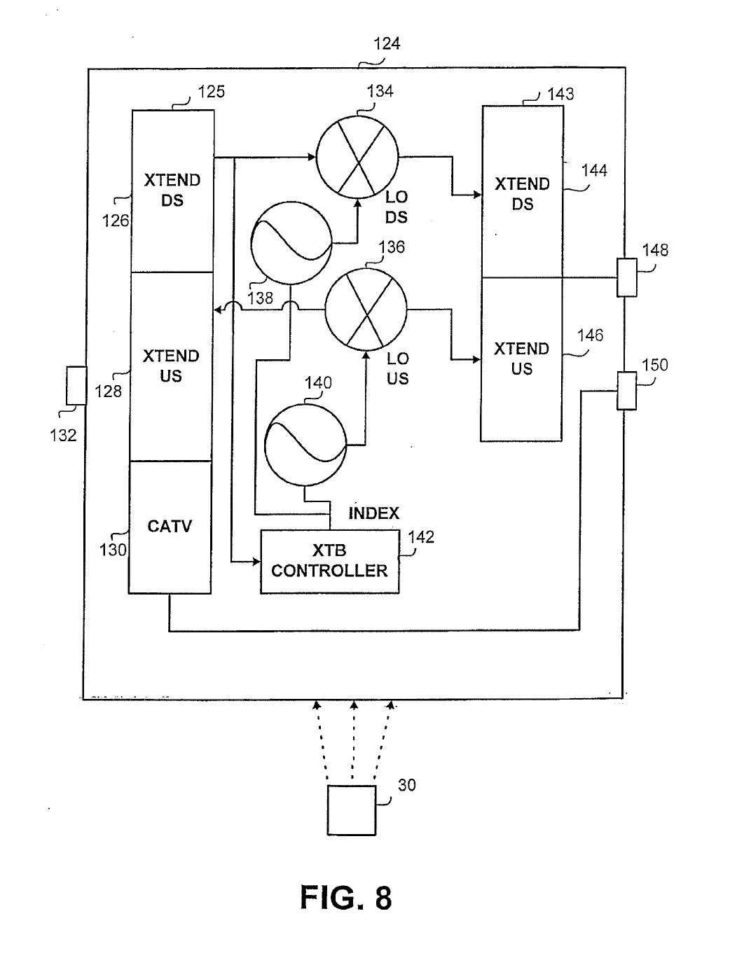

FIG. 8 provides a schematic diagram of the XDTV Extended Set Top Box device (XTB). The down conversion frequency of the XDTV XTB is controlled from the head end over a control channel. This allows the XDTV XTB to select one of the four overlay sub-bands for potential display for the specific network subscriber. XTB 124 includes a port 132 leading to a wall outlet (not shown) via which the box 124 receives and sends the entire 3 GHz frequency range spectrum of the signal carrying the modulated frequency elements of the content information. The XTB 124 further includes a triplexer device 125 having three frequency selective sections 126, 128, 130, a diplexer device having two frequency selective sections 144, 146, an XTB micro-controller device 142, two voltage controlled oscillator devices (VCOs) 138, 140, and two mixer devices 134, 136. The selection of the channels out of the specifically generated package is controlled by the subscriber via a remote controller device 30. The selection of the complete programming package associated with a specific spectrum overlay is controlled by control signals sent from the head end via a control channel in accordance with pre-defined tables including a list of subscribers and the associated programming packages. The control signals affect the frequency of the down-conversion and the frequency of the up-conversion within the XTB 124. The signal having a substantially extended bandwidth of about 3 GHz and above is fed into the XTB 124 from the CATV plant via a wall outlet and the port 132 associated with the XTB 124. The signal is fed into a triplexer device 125 having a set of frequency selective sections 126, 128, 130. The signal is appropriately divided by the triplexer 125 where the extended bandwidth portion is fed to a mixer 134. The mixer 134 in association with the VCO 138 down converts the frequency of the appropriate spectrum overlay within the extended band of the signal. The signal is fed to diplexer 143 separated by the frequency section 143 and sent to the port 148 for the display devices of the subscriber. The operation of the VCO 138 and mixer 138 are controlled by the XTB micro-controller 142, which is controlled in turn by the control signals received from the head end. The analog portion or the CATV band of the signal is separated from the combined signal by the frequency selective circuit 130, fed directly to the output port 150 of the XTB and sent to the display devices of the subscriber. The upstream data sent by the subscriber is fed via the port 148 into the diplexer 143 separated by the frequency selective section 146 and re-introduced into the combined signal by the mixer 136 and VCO 140 controlled by the micro-controller 142 which in turn is controlled by the control signals received from the head end via a specific control channel. The upstream signal is fed back to the triplexer 125 combined into the combined signal and fed back to the network via the port 132, via the wall outlet back to the network. It would be readily perceived by one with ordinary skills in the art that the above description is exemplary only. The same objective could be accomplished using different components, interconnections, values and procedures. Various additional functions could be added to enhance the operation of the device and diverse advanced applications could be contemplated that could benefit from the concept of the spectral overlays.

While the first preferred embodiment of the invention was substantially based on the system and method disclosed in the co-pending patent application incorporated herein by reference, in the second preferred embodiment of the present invention the methodology is different in several aspects from the concept and implementation disclosed in the co-pending patent application. The principal differences are as follows: a) the CATV network is upgraded to carry only the new downstream capacity, i.e. the network is not upgraded to the about 3 GHz capacity with symmetrical upstream and downstream but is only provided only with a downstream pass band of about 1200-1650 MHz, which is sufficient to carry the new content of the XDTV, b) the upgrade components differ from the basic system components. In the original system the amplification element is placed in parallel to the existing line extender (LEX). The XDTV amplification element consists a pair of Amplifying Extended Splitters (AMXSP), referred to as the AMXSP Master and the AMXSP Slave. The AMXSP Pair is placed before and after the existing line extender (LEX) and c) the frequency conversion units, the extended hub station at the fiber node and the XTB at the customer premises in the XDTV implementation have a different internal structure and a different pass band.

The XDTV system can carry an extended amount of CATV data traffic by extending the available bandwidth. This added traffic is converted back to standard CATV frequencies in a manner that replaces analog channels having one stream of video per channel with digital channels that can carry several video streams per channel. Thus, the CATV network subscriber could be served with a plurality of additional digital channels. For this purpose the subscriber can use the existing digital set top box (DSTB), which was originally designed and built for the about 80-860 MHz amount of digital channels. The digital channels are used in the upper band (the about 550-750/860 MHz frequency band) as the proper distribution of the analog channels must be maintained as before the specific upgrade.

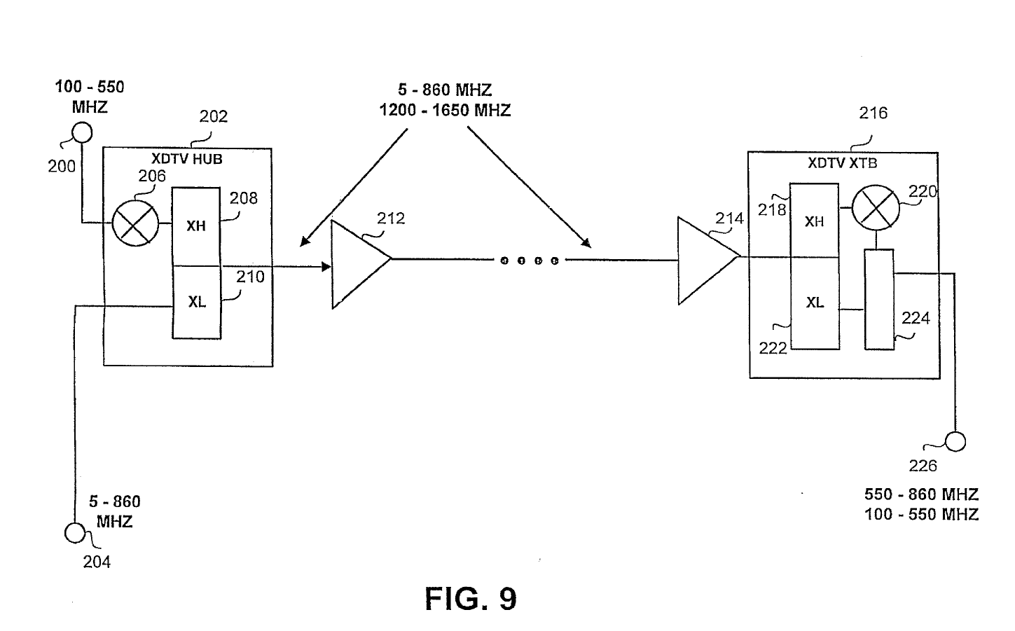

FIG. 9 describes the Frequency Overlay Method utilized for accomplishing the objectives of the system and method in accordance with the second preferred embodiment of the present invention. The XDTV hub station 202 has two input ports via which two inputs 200 and 204 are received. The input 200 provides the original about 5-860 MHz channels including the about 100-550 MHz frequency range of the analog channels. The input 204 provides the new digital channels at a spectrum of about 100-550 MHz frequency range. The XTDV hub station 202 combines the two inputs 200, 204 to one multiplexed signal that carries the original about 5-860 MHz and the new about 100-550 MHz at the extended band of frequencies spanning 1200-1650 MHz. The amplification across the coaxial plant is performed by the LEX 212, 214 for the 5-860 MHz band. Each LEX 212, 214 is associated with an Amplifying Extended Splitters (AMXSP) Pair, which performs the amplification of the 1200-1650 MHz band. At the subscriber premises the XTB 216 performs a reverse frequency conversion. The output signal 226 consists of the new about 100-500 MHz frequency range including the digital channels as well as the original about 550-860 MHz frequency range including the digital channels. A Digital Set Top Box (DSTB) receives the output signal 226 in the entire pass band of about 100-860 MHz. Note should be taken that the upstream frequency band having a range of about 5-42 MHz operates as a portion of the about 5-860 MHz frequency band. It would be readily perceived by one with ordinary skills in the art that the above description of the method is exemplary only. The same or similar objectives could be accomplished using somewhat different configurations consisting of different components, alternative interconnections, modified component values and the like. Various additional functions could be added to enhance the method and diverse advanced applications could be contemplated that could benefit from the concept underlying the method.

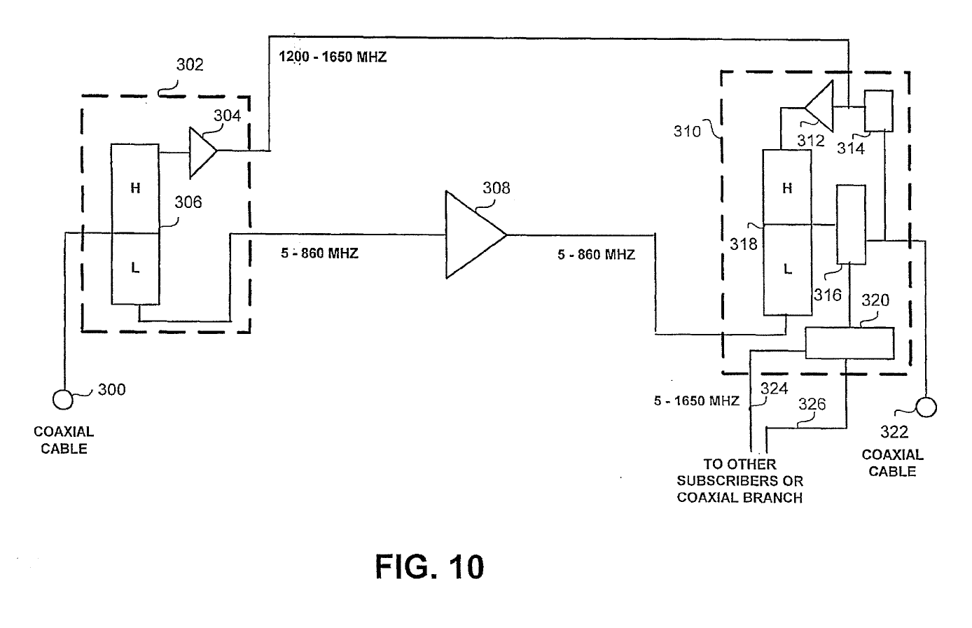

Referring now to FIG. 10, in the second preferred embodiment of the present invention the objectives of the XDTV system are accomplished through the operation of three principal elements: a) the XDTV hub station 302 that is located at the fiber node, b) the Amplifying Extended Splitters (AMXSP) Pair 304, 312, which are placed in the location of the existing line extender (LEX) 308 and c) the XDTV XTB 310, which is located at the subscribers premises. The AMXSP Pair 304, 312 perform the amplification of the new extended frequency band of the about 1200-1650 MHz, in parallel to the existing LEX 308, which operates in the about 5-860 MHz frequency band. The method for connecting the AMXSP Pair 304, 312 and the LEX 308 was described hereinabove in association with FIG. 9. The AMXSP Pair 304, 312 include an AMXSP Master 312 and an AMXSP Slave 304. The RF input from the coaxial cable 300 is split at the input to the Slave 304 by a diplexer 306. One output (L) of the diplexer 306 relays the about 5-860 MHz frequency band to the LEX 308 for amplification. The second output (H) of the diplexer 306 carries the about 1200-1650 MHz frequency band. This band is amplified in the Slave 304 and then relayed to the Master 312 for additional amplification. The two amplified signals are combined to the coaxial cable at the Master 312 prior to being send to the coaxial cable 322. The AMXSP Pair 304, 312 performs also the power splitting function 314 and replaces the standard about 5-860 MHz splitters. Splitter devices are included in the Master 312 to send power to other branches of the network or to the subscribers along the coaxial path. The Master 312 contains the power supply, which feeds also the Slave 304. The coaxial cable connecting the Slave 304 and the Master 312 further carries the DC power for the Slave 304. The power is combined with the RF signal via suitable RF chokes.

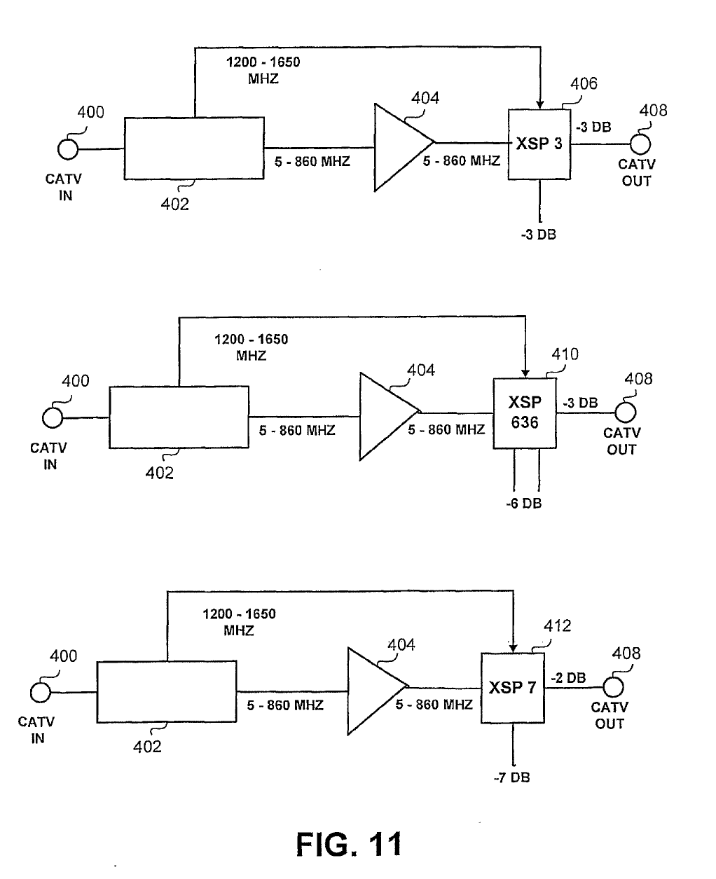

Referring now to FIG. 11, the AMXSP Master while serving as a power splitter can have different power splitting and power coupling values. The sample configurations appearing on the drawing depict a two-way splitter 406 with two −3 dB outputs, a splitter with one −3 dB output to the line 406 and two 06 dB outputs to other network branches and subscribers, and a coupler 412 with one −2 dB to the line 408 and a −7 dB to other network branches and/or subscribers. It would be easily understood that in other preferred embodiments of the invention additional splitting values or different splitting ratios could be implemented.

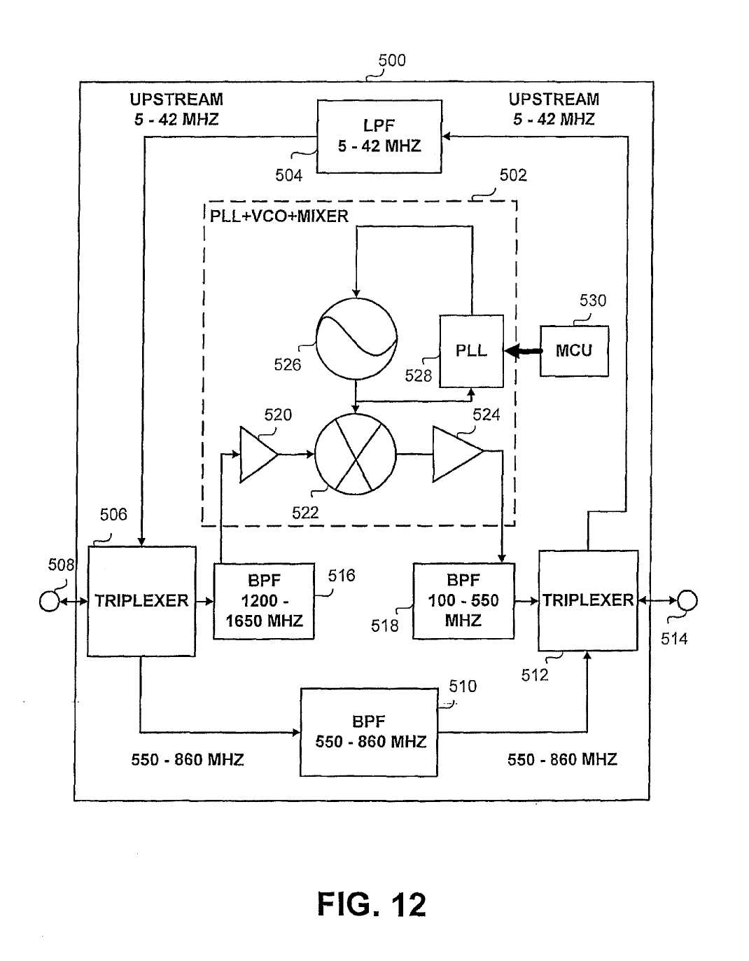

Referring now to FIG. 12 that depicts the schematic block diagram of the XDTV XTB. The XTB 500 performs the following tasks: a) conversion of the about 1200-1650 MHz frequency band to the new about 100-550 MHz frequency band, b) combining the new about 100-550 MHz band and the old about 550-860 MHz digital band, and c) power amplification the adequate power levels required by the CPE including the digital set top box (DSTB) and the cable modem. The triplexer 506 at the input 508 splits the pass band of the coaxial cable to three sub-bands: a) an about 550-860 MHZ downstream frequency range that carries the old digital channels, b) the about 1200-1650 MHz downstream frequency range that carries the new digital channels, and c) the about 5-42 MHz upstream frequency range utilized to preserve the upstream characteristics of the CATV plant. The about 1200-1650 MHz sub-band is down-converted by the PLL/VCO/Mixer 502 (controlled by a programmable micro-controller unit (MCU) 530) to about 100-550 MHz. The about 550-860 MHz sub-band is relayed to the output triplexer 512 directly. Consequently the two downstream sub-bands are combined at the output triplexer 512 in order to create a complete pass band for the digital channels from about 100 MHz to about 860 MHz. The complete about 100-860 MHz band is fed to the subscriber's digital set top box (DSTB) via the output port 514. The about 5-42 MHz upstream is relayed to the coaxial cable without being processed and therefore its characteristics is substantially preserved. It would be readily perceived by one with ordinary skills in the art that the above description of the extended top box (XTB) is exemplary only. The same objectives could be accomplished using somewhat different components, alternative interconnections, different component values and the like. Diverse supplementary functions could be added to enhance the operation of the top box device and diverse advanced applications could be contemplated that could benefit from the concept underlying the operation of the device.

It will be appreciated by persons skilled in the art that the present invention is not limited to what has been particularly shown and described hereinabove. Rather the scope of the present invention is defined only by the claims, which follow.

1. In an electronic content distribution network a system for the expansion of the frequency spectrum of transmission, through coaxial cables by the selective generation and introduction of high frequency spectrum overlays, the system comprising:
at least one hub station to receive a first signal and a second signal from a network head end, wherein a frequency spectrum of said first signal, substantially in the range of 5-860 MHz, is at least partially overlaid by a frequency spectrum of said second signal, substantially in the range of 100-550 MHz, to combine the first signal and the second signal to at least one third combined signal in a third frequency spectrum including said first frequency spectrum, substantially in the range of 5-860 MHZ and an extended frequency spectrum distinct from said first frequency spectrum, said third combined signal carrying said first signal on said first frequency spectrum and said second signal on said extended frequency spectrum portion;
a first amplifying extended splitter device placed before a line extender device, said first amplifying extended splitter device to selectively amplify and process the extended frequency spectrum portion of the at least one third combined signal;
a second amplifying extended splitter device placed after a line extender device, said second amplifying extended splitter device to selectively amplify and process the extended frequency spectrum of the at least one third combined signal; and
at least one set top box to down-convert said second signal from said extended frequency spectrum into said second frequency spectrum, substantially in the range of 100-550 MHz, to replace a portion of said first signal, having a sub frequency spectrum, substantially in the range of 100-550 MHz, with said second signal, to create a fourth signal carrying said second signal on said second frequency spectrum and a portion of said first signal on a respective portion of said first spectrum, substantially in the range of 550-860 MHz, which is not overlaid by said second spectrum.

2. The system of claim 1 further comprises at least one line extender device to amplify at least a portion of the at least one third signal.

3. The system of claim 1, further comprising a network head end which comprises the elements of:
a first adder and radio frequency multiplexer device to combine a plurality of analog video streams, a plurality of digital video streams, and a plurality of data downstream streams into said first signal and separating a plurality of data upstream streams from the first signal;
a second adder and radio frequency multiplexer device to combine a plurality of digital streams into said second signal and separate a plurality of data upstream streams from the second signal; and
a controller device to control the operation of the at least one set top box in accordance with pre-defined control parameters.

4. The system of claim 1 wherein the hub station comprises the elements of:
a mixer unit to combine the first signal and the second signal into the at least one third combined signal; and
a first amplifying extended splitter to perform amplification of the second signal.

5. The system of claim 1 wherein the set top box comprises the elements of:
a second amplifying extended splitter to perform amplification of the second signal;
a first triplexer unit including at least one low pass filter device and at least two band pass filter devices to separate the at least one third combined signal to at least a first sub-band including said second signal on said extended frequency spectrum and a second sub-band including a portion of said first signal on a respective portion of said first spectrum which is not overlaid by said second spectrum;
a mixer unit to down convert said first sub-band into said second frequency spectrum; and
a second triplexer to combine the down converted first sub-band and the second sub-band into said forth signal.

6. The system of claim 1 wherein the electronic content distribution network is a CATV distribution network.

7. The system of claim 1 wherein the electronic content distribution network is a cellular network.

8. The system of claim 1 wherein the third frequency spectrum is within a range of 5 MHz to 1650 MHz.

9. In an electronic content distribution network a method for the expansion of the frequency spectrum, transmitted through coaxial cables, by the selective generation and introduction of high frequency spectrum overlays, the method comprising the steps of:
combining a plurality of analog streams, digital streams and downstream data streams into a first combined signal modulated across a first frequency spectrum, substantially in the range of 5-860 MHZ;
combining a plurality of digital streams into at least one second combined signal modulated across at least one respective second frequency spectrum, in an extended range distinct from said first frequency range;
converting at least one of said at least one second combined signals from said respective second frequency range to a converted frequency spectrum, substantially in the range of 100-550 MHz which at least partially overlay said first frequency range; and
replacing a portion of said first combined signal having a frequency spectrum said portion is substantially in the range of 100-550 MHz with said at least one second combined signal converted to said converted frequency spectrum, substantially in the range of 100-550 MHz, to create at least a third combined signal across said first frequency spectrum, substantially in the range of 5-860 MHz, said third combined signal carrying said at least one second combined signal and a second portion of said first signal, having a frequency spectrum substantially in the range of 550-860 MHz, on said second portion of said first frequency spectrum which is not overlaid by said at least one second combined signal.

10. The method of claim 9 wherein each of said at least one second signals is modulated across a 500 MHz frequency band.

11. The method of claim 9 wherein the combination of the streams included in the first signal is preserved in accordance with the pre-defined programming package.

12. The method of claim 9 wherein an at least one upstream data portion of the at least one overlaid signal is suitably preserved for upstream signal traffic within the electronic content distribution network.

13. In an electronic content distribution network a system for the expansion of the frequency spectrum, transmitted through coaxial cables, by the selective generation and introduction of high frequency spectrum overlays, the system comprising:
at least one hub station to receive a first signal and a second signal from a network head end, wherein a frequency spectrum of said first signal, substantially in the range of 5-860 MHz, is at least partially overlaid by a second frequency spectrum of said second signal, substantially in the range of 100-550 MHz, to combine the first signal and the second signal to at least one third combined signal including said first frequency spectrum, substantially in the range of 5-860 MHZ and an extended frequency spectrum distinct from said first frequency spectrum, said third combined signal carrying contents of said first signal on said first frequency spectrum and contents of said second signal on said extended frequency spectrum portion;
an amplification element placed in parallel to a line extender device, said amplification element to selectively amplify and process the extended frequency spectrum portion of the at least one third combined signal; and
at least one set top box to down-convert said second signal from said extended frequency spectrum into said second frequency spectrum, substantially in the range of 100-550 MHz, to replace a portion of said first signal, having a sub frequency spectrum, substantially in the range of 100-550 MHz, with said second signal, to create a fourth signal carrying said second signal on said second frequency spectrum and a portion of said first signal, substantially in the range of 550-860 MHz, on a respective portion of said first spectrum which is not overlaid by said second spectrum.

14. The system of claim 13 further comprises the element of at least one line extender device to amplify at least one portion of the at least one third signal combined from the first input signal and the second input signal.

15. The system of claim 13, further comprising a network head end which comprises the elements of:
a first adder and radio frequency multiplexer device to combine a plurality of analog video streams, a plurality of digital video streams, and a plurality of data downstream streams into said first signal and separating a plurality of data upstream streams from the first signal;
a second adder and radio frequency multiplexer device to combine a plurality of digital streams into said second signal and separate a plurality of data upstream streams from the second signal; and
a controller device to control the operation of the at least one set top box in accordance with pre-defined control parameters.

16. The system of claim 13 wherein the hub station comprises the element of a mixer unit to combine the first signal and the second signal into the at least one third combined signal.

17. The system of claim 13 wherein the set top box comprises the elements of:
a first triplexer unit including at least one low pass filter device and at least two band pass filter devices to separate the at least one third combined signal to at least a first sub-band including said second signal on said extended frequency spectrum and a second sub-band including a portion of said first signal on a respective portion of said first spectrum, substantially in the range of 550-860 MHz, which is not overlaid by said second spectrum;
a mixer unit to down-convert said first sub-band into said second frequency spectrum, substantially in the range of 100-550 MHz; and
a second triplexer to combine the down-converted first sub-band and the second sub-band into said forth signal.

18. The system of claim 13 wherein the electronic content distribution network is a CATV distribution network.

19. The system of claim 13 wherein the extended frequency spectrum is within an about 1 to 3 GHz frequency range.

20. The method of claim 9 further comprising the step of selecting in a set top box device at least one second signal to be converted, said selected second signal corresponding to a pre-defined programming package intended for distribution to at least one subscriber associated with said set top box device wherein each of said at least one second signals consists of a plurality of digital channels in accordance with pre-defined programming package intended for distribution to at least one subscriber.
